(19) United States
(12) Patent Application Publication
(10) Pub. No.: US 2011/0067871 A1
(43) Pub. Date: Mar. 24, 2011

(54) Methods For Regulating Flow In Multi-Zone Intervals

(76) Inventors: Jason A. Burdette, Houston, TX (US); Dieter Postl, Manvel, TX (US); Bruce A. Dale, Sugar Land, TX (US); Federico A. Tavarez, Pearland, TX (US); Ted A. Long, Sugar Land, TX (US)

(21) Appl. No.: 12/933,018

(22) PCT Filed: Mar. 5, 2009
(86) PCT No.: PCT/US09/36198

§ 371 Date: Sep. 16, 2010

Related U.S. Application Data
(60) Provisional application No. 61/128,508, filed on May 22, 2008.
(60) Provisional application No. 61/128,508, filed on May 22, 2008.

(51) Int. Cl. E21B 43/11; G06G 7/48

(52) U.S. Cl. 166/298; 703/10

(57) ABSTRACT

Methods of regulating flow in a hydrocarbon well include identifying at least two dissimilar zones in an interval of a well, perforating a well completion in the interval according to a limited-entry perforation strategy, and re-perforating the well completion in the interval according to a re-perforating strategy. The limited-entry perforation strategy is adapted to produce a plurality of limited-entry perforations. The limited-entry perforation strategy varies the perforations within the interval based at least in part on dissimilarities between the at least two dissimilar zones. The re-perforation strategy produces a plurality of re-perforations and is based at least in part on the limited-entry perforation strategy. The re-perforation strategy is adapted to at least substantially align a portion of the re-perforations with a portion of the limited-entry perforations.

### CROSS-REFERENCE TO RELATED APPLICATIONS

This application claims the benefit under 35 U.S.C. §119(e) to U.S. Provisional Application Ser. No. 61/128,508, entitled “METHODS FOR REGULATING FLOW IN MULTI-ZONE INTERVALS,” filed on 22 May 2008, which application is incorporated herein by reference in its entirety for all purposes.

### FIELD

The present disclosure relates generally to methods for regulating flow in multi-zone wells. More particularly, the present disclosure relates methods of treating multi-zone wells, including perforating the well, to regulate flow into or out of the formation.

### BACKGROUND

This section is intended to introduce the reader to various aspects of art, which may be associated with embodiments of the present invention. This discussion is believed to be helpful in providing the reader with information to facilitate a better understanding of particular techniques of the present invention. Accordingly, it should be understood that these statements are to be read in this light, and not necessarily as admissions of prior art.

In the modern hydrocarbon industry it is not uncommon for wells to intersect multiple reservoirs or to penetrate large reservoirs having varied formation properties or characteristics within a single reservoir. For example, it is not uncommon for operators to commingle multiple reservoirs to maximize the economics of a single well. Additionally, some wells are being drilled into formations having 3,000-8,000 foot long pay intervals. In either of these scenarios, or for a variety of other reasons, a given well may intersect multiple ‘zones’ of a formation into which, or out of which, fluid flow needs to be regulated.

For example, an operator of a producing well commingling multiple reservoirs may desire to limit the production from one reservoir while maximizing the production from another reservoir so as to control and/or change the hydraulics that drive the production of the well or of another, near-by well. Similarly, fluids are often injected into wells for a variety of reasons including causing the injected fluid to have a desired impact on a particular zone or region of the well, such as to change a property of the well being injected or to change the hydraulics operating on the well or other wells. One exemplary injection operation common in well operations is the application of a treatment, such as a carbonate matrix acidizing fluid or a fracture fluid, to change the near-well properties of the well.

FIG. 1 illustrates a common problem faced by operators of multi-zone wells receiving a stimulation treatment. FIG. 1(a) schematically illustrates a basic multi-zone well 10 having a high permeability zone 12 and a low permeability zone 14 in the same well. FIG. 1(b) schematically illustrates the conventional process for applying a stimulation treatment to the well of FIG. 1(a). As illustrated, the well is perforated according to conventional methods and an acid treatment is applied through the perforations (according to conventional matrix acidizing techniques). FIG. 1(b) illustrates that due to the differing permeabilities of the high perm zone 12 and the low perm zone 14, the acid is able to penetrate further into the high perm zone 12 treating more of the formation. Depending on the relative properties of the two zones 12, 14, the applied treatments may preferentially flow into the higher perm zone 12 and, in some implementations, may result in little or no flow into the lower perm zone 14. Typically, the treatments applied to a well are stimulation treatments intended to improve the producibility and/or injectability of the well and sometimes of particular zones. For example, a treatment on the schematic well of FIG. 1 may be intended to apply a greater degree of treatment on the zone having lower permeability. However, the higher perm zone 12 may act as a thief zone preventing the treatment fluid from entering the target lower permeability zone 14.

FIG. 1(c) schematically illustrates the result of such matrix acidizing in a multi-zone well 10. As illustrated, the high perm zone 12 has received a greater degree of the treatment and is now producing at a rate far greater than the low perm zone 14 (as indicated by the length of the flow arrows 16). As described above, the higher perm zone 12 prevented the treatment from reaching the target zone and the treatment failed to accomplish the objective. The results illustrated schematically in FIGS. 1(b) and 1(c) reveal the challenges faced when treating, injecting, and/or producing a multi-zone well 10.

FIG. 1 illustrates at least some of the reasons that operators desire to control the flow of fluids into or out of the distinct zones during injection, treatment, and/or production operations. Generally, to the extent that an operator has greater control over the fluid flow in a particular zone, the operator is better able to control the operations and can better manage the life-cycles of the well, including each of the distinct zones.

Conventionally, operators have relied upon a variety of options for controlling flows in a multi-zone well. For example, bridge plugs and packers have conventionally been used to provide mechanical isolation between reservoirs or zones. While such technologies provide effective isolation and control, there is significant cost in deploying such technologies and operational risks in their deployment and retrieval. Ball sealers have also been used to temporarily seal off some perforations while diverting flow to other perforations. However, ball sealer operations include significant uncertainty in and lack of control over ball placement. Moreover, ball sealers provide only a questionable degree of sealing against the perforations. For these and other reasons, ball sealers are less than optimal.

Other options available to help control flows in a multi-zone well include chemical diversion. Chemical diversion techniques are known in the industry but are recognized to be generally incapable of providing enough resistance or diversion to overcome the extreme permeability, pressure, and skin contrasts that frequently exist between zones. Additionally, the complexity of designing and implementing a suitable chemical diversion treatment, including the subsequent clean up steps, contribute to rendering this technique undesirable for many applications.

Each of these conventional techniques for isolating or controlling fluid flow in multi-zone wells rely upon adding some element to the well to divert (ball sealers and chemical diversion) or block the fluid flow (packers and plugs). Each of these techniques increase costs due to the additional materials and operational complexity and risks. Significantly, each of these control options presents the possibility (or requirement) that the added equipment or materials will need to be removed from the well. Often the retrieval step adds substantial risks to the operations.

“Limited-entry perforations” have previously been used in fracture treatment operations. The limited-entry perforation techniques perforate the casing of a well in a manner that effectively chokes the flow through the perforations. Such limited-entry perforations are typically smaller in diameter and fewer in number than conventional perforated completions. While limited-entry perforation techniques have been used for fracture treatment operations, to the knowledge of the present inventors, its use has not expanded to general applicability in production or injection operations and has not been used in matrix acidizing operations. Extension of the limited-entry perforation techniques is believed to have been limited because the spacings between the perforations is generally perceived to be far too large for use in other applications, such as matrix acidizing. Additionally, while the choke effect may be a benefit during the treatment stage, it may be undesired during subsequent production or injection operations. Similarly, while a given degree of choke may be desired during a phase of a production operation, a lesser choke effect may be desired during a subsequent phase of the production operation. Accordingly, limited-entry perforations have been limited to fracture treatment operations.

Other related material may be found in at least U.S. Pat. Nos. 3,712,379; 4,917,188; 5,058,676; 5,273,115; 5,947,200; 6,626,241; 7,059,407; and 7062420.

### SUMMARY

In some implementations of the present invention, methods of regulating flow in a hydrocarbon well include identifying at least two dissimilar zones in an interval of a well, perforating a well completion in the interval according to a limited-entry perforation strategy, and re-perforating the well completion in the interval according to a re-perforating strategy. The limited-entry perforation strategy is adapted to produce a plurality of limited-entry perforations. The limited-entry perforation strategy varies the perforations within the interval based at least in part on dissimilarities between the at least two dissimilar zones. The re-perforation strategy produces a plurality of re-perforations and is based at least in part on the limited-entry perforation strategy. The re-perforation strategy is adapted to at least substantially align a portion of the re-perforations with a portion of the limited-entry perforations.

In some implementations, the at least two dissimilar zones are dissimilar in at least one formation property, which may include one or more property selected from permeability, porosity, skin, lithology, reservoir pressure, stress state, and fluid saturation. In some implementations, the at least two dissimilar zones are within a single isolation interval, such as may be formed by cooperating isolation devices.

In some implementations, additional steps may be performed. For example, some implementations may include designing the limited-entry perforation strategy based at least in part on dissimilarities between the at least two dissimilar zones. Additionally or alternatively, some implementations may include obtaining formation property data related to the interval. For example, designing the limited-entry perforation strategy may utilize the formation property data to adapt the limited-entry perforation strategy to regulate flow into or out of the dissimilar zones. Additionally or alternatively, some implementations may include utilizing one or more models of the interval to simulate effects of various limited-entry perforation strategies. For example, designing the limited-entry perforation strategy may be based at least in part on the one or more models of post-limited-entry perforation performance. Additionally or alternatively, the plurality of limited-entry perforations may apply a choke on fluid flow into or out of each of the zones and designing the limited-entry perforation strategy may include selecting perforation properties for each zone to prepare each zone for re-perforating to remove the choke.

Still additionally or alternatively, some implementations may include designing the re-perforation strategy. For example, at least a portion of the re-perforation strategy may be designed concurrently with designing the limited-entry perforation strategy. Additionally or alternatively, the re-perforation strategy and the limited-entry perforation strategy may be designed to cooperate to regulate flow within the interval.

In some implementations, the methods of the present disclosure may be utilized in intervals including at least one high permeability zone and at least one low permeability zone. For example, the limited-entry perforation strategy may be adapted to selectively perforate the dissimilar zones to have a greater impact on the at least one low permeability zone than on the at least one high permeability zone. In some implementations, for each of the dissimilar zones, the limited-entry perforation strategy varies one or more perforation property selected from number of perforations, perforation diameter, perforation density, perforation depth, perforation phasing, perforation sequencing, preferred perforation distribution, preferred perforation gun disposition, and preferred perforation gun orientation.

As indicated above, the present methods may include one or more additional steps. An exemplary additional step may include pumping a treatment fluid into the interval following the limited-entry perforating and before the re-perforating. When a treatment fluid is pumped into the interval, the limited-entry perforating strategy may be adapted to regulate flow of the treatment fluid into one or more of the dissimilar zones. Referring back to the example of the dissimilar zones including at least one higher permeability zone and at least one lower permeability zone, the treating fluid may be selected to increase permeability. In such implementations, the limited-entry perforating strategy may be adapted to preferentially allow treatment fluid to enter one or more lower permeability zones. A variety of treatment fluids may be used, including treatment fluids selected to form wormholes in the zones behind the limited-entry perforations. When wormholes are formed behind limited-entry perforations, at least a portion of the re-perforations may be at least substantially aligned with at least a portion of the wormholes. Exemplary treatment fluids may additionally or alternatively include carbonate matrix acidizing fluids and/or fracture fluids. These treatment fluids may be pumped into the limited entry perforations with pump rates and/or pressures, fluid volumes, and fluid properties that yield an enlarged wormhole cavity or fracture directly behind the limited entry perforations. This enlarged treated zone provides a more substantial target for alignment of re-perforations with limited entry perforations and/or the wormhole cavity.

In some implementations, the treatment fluid is selected to change a formation within each of the zones. Such methods may continue by obtaining data regarding one or more formation property for each of the zones following the pumping of the treatment fluid. Still further, these methods may include designing the re-perforation design strategy based at least in part on information regarding the formation properties in each zone following the pumping of the treatment fluid.

Any one or more of the above aspects of the present methods may be implemented alone or in cooperation to utilize a well for production or injection operations. Additionally or alternatively, any one or more of the above aspects may be implemented in whole or in part with systems, including field equipment and/or computing equipment (which may also be in the field), adapted to perform and/or assist with one or more of the steps of the present methods.

The present disclosure further provides a method for designing treatments for a hydrocarbon well to regulate flow within the well. Such methods may include 1) obtaining data regarding one or more properties of a well having at least two dissimilar zones within a single interval; 2) developing a simulator of the interval based at least in part on the obtained data and one or more physics-based rules; 3) designing a limited-entry perforating strategy based at least in part on the obtained data and utilizing the simulator to model the interval; and 4) designing a re-perforating strategy based at least in part on the limited-entry perforating strategy and adapted to fluidically connect a plurality of re-perforations with a plurality of limited-entry perforations.

Similar to the discussion above, the methods for designing treatments may consider intervals in which the at least two zones are dissimilar in at least one formation property selected from permeability, porosity, skin, lithology, reservoir pressure, stress state, and fluid saturation. In some implementations, the simulator may be adapted to simulate completion and near-well physics. Additionally or alternatively, the simulator may be utilized to aid in designing the limited-entry perforating strategy, such as by assisting in determining desired stimulation levels for each of the zones. Additionally or alternatively, designing the limited-entry perforating strategy may include determining preferred treatment fluid distributions to the at least two zones based at least in part on the utilization of the simulator.

In some implementations, designing the limited-entry perforating strategy may include determining at least one of preferred perforation diameter, preferred perforation density, preferred total perforations, preferred perforation depth, preferred perforation phasing, preferred perforation sequencing, preferred perforation distribution, preferred perforation gun disposition, and preferred perforation gun orientation to regulate flow within the interval.

Additionally or alternatively, methods for designing treatments may include obtaining updated data regarding the interval following application of the limited-entry perforation strategy and a treatment routine, and updating the simulator based at least in part on the updated data. In such implementations, the step(s) of designing a re-perforating strategy may be based at least in part on the updated simulator. An exemplary treatment routine may include pumping an acid into the well forming wormholes associated with limited-entry perforations created by the application of the limited-entry perforation strategy. The step(s) of designing the re-perforating strategy may be adapted to fluidically connect a plurality of re-perforations with a plurality of the wormholes associated with limited-entry perforations.

The re-perforating strategy designing may include a variety of steps and/or components, such as those described herein. Exemplary aspects of designing the re-perforation strategy may include determining at least one of preferred perforation diameter, preferred perforation density, preferred total perforations, preferred perforation depth, preferred perforation phasing, preferred perforation sequencing, preferred perforation distribution, preferred perforation gun disposition, and preferred perforation gun orientation to fluidically connect a plurality of re-perforations with a plurality of limited-entry perforations.

### BRIEF DESCRIPTION OF THE DRAWINGS

The foregoing and other advantages of the present technique may become apparent upon reading the following detailed description and upon reference to the drawings in which:

FIG. 1 is a schematic illustration of a sequence of steps performed on a well during a conventional treatment operation;

FIG. 2 is a schematic illustration of a sequence of steps performed on a well during treatment operations according to the present disclosure;

FIG. 3 illustrates a schematic flow chart of methods within the scope of the present disclosure;

FIG. 4 illustrates another schematic flow chart of methods within the scope of the present disclosure;

FIG. 5 is a schematic illustration of a portion of a well following a treatment operation;

FIG. 6 is a schematic illustration of a portion of a well showing the challenges of a re-perforation strategy;

FIG. 7 is another schematic flow chart of methods within the scope of the present disclosure;

FIG. 8 is another schematic flow chart of methods within the scope of the present disclosure; and

FIG. 9 is another schematic flow chart of methods within the scope of the present disclosure.

### DETAILED DESCRIPTION

In the following detailed description, specific aspects and features of the present invention are described in connection with several embodiments. However, to the extent that the following description is specific to a particular embodiment or a particular use of the present techniques, it is intended to be illustrative only and merely provides a concise description of exemplary embodiments. Moreover, in the event that a particular aspect or feature is described in connection with a particular embodiment, such aspects and features may be found and/or implemented with other embodiments of the present invention where appropriate. Accordingly, the invention is not limited to the specific embodiments or implementations described below. But rather, the invention includes all alternatives, modifications, and equivalents falling within the scope of the appended claims.

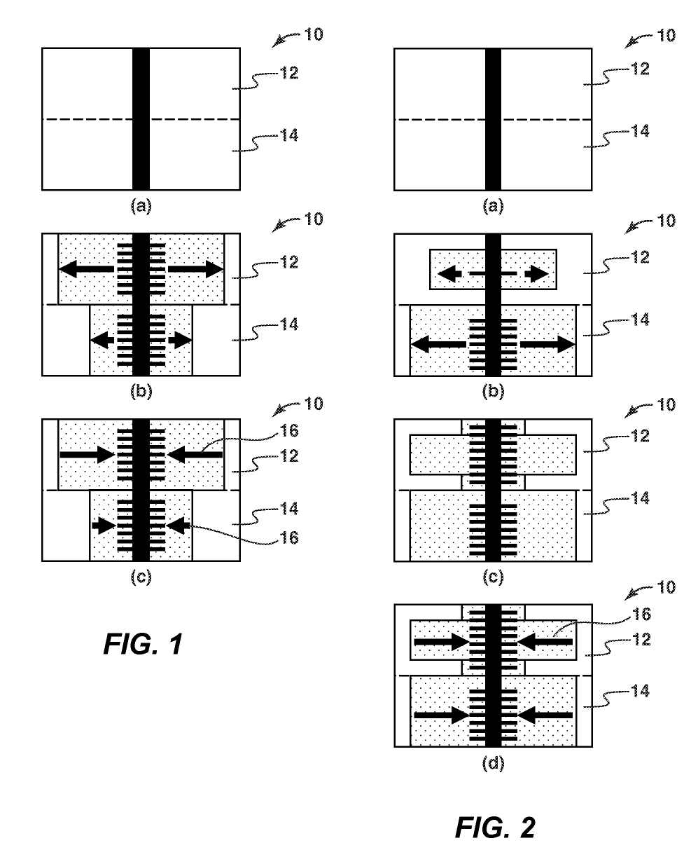

FIG. 2 illustrates a series of schematically represented wells having two different zones. Similar to FIG. 1, the series of illustrations in FIGS. 2(a)-2(d) represent an exemplary method of perforating a well to control the fluid flow in the different zones. However, FIG. 2 schematically illustrates the impact on the well of an application of the methods disclosed herein. While FIG. 2 represents an exemplary impact of the present methods, FIG. 2 is presented here to provide a framework for the subsequent discussion of the methods of the present disclosure. The illustration of the impacts on the subterranean formation is merely exemplary and is therefore not limiting. The precise impact on a well, including changes to permeability and other properties, will vary depending on the manner in which the present methods are carried out and the well or formation properties on which the present methods are carried out.

FIG. 2(a), like FIG. 1(a), illustrates a schematic section of a multi-zone well 10 that is oversimplified for the purposes of this illustration. The multi-zone well 10 includes a high permeability (perm) zone 12 and a low permeability (perm) zone 14. FIG. 2(b) illustrates the conditions of the respective zones following application of a limited-entry perforation strategy followed by a stimulation treatment. Specifically, FIG. 2(b) illustrates that the upper high perm zone 12 is perforated by a single perforation 18 while the lower low perm zone 14 is perforated by a plurality of perforations 18. Further, FIG. 2(b) illustrates that the limited-entry perforation and treatment strategy affects a larger portion of the formation in the low perm zone 14 than in the high perm zone 12 despite the differences in permeabilities. As will be described in greater detail below, the limited-entry perforation strategy is adapted to limit the treatment fluid flow into the high perm zone 12 while encouraging treatment flow into the low perm zone 14.

Continuing with FIG. 2(b), the schematic representation of the perforations 18 fails to illustrate the variety of manners in which perforations can be varied or configured to provide a different degree of perforation to one zone relative to another zone. For example, the high perm zone 12 may have fewer perforations than the low perm zone 14. Additionally or alternatively, the diameter of the perforations in the respective zones may be varied. Still additionally or alternatively, the charge used to create the perforations may be varied resulting in perforations penetrating the formation to greater or lesser depths. Accordingly, as used herein, the limited-entry perforation strategy is not confined to application of a particular perforation configuration. Rather, the limited-entry perforation methods of the present disclosure include any combination of perforations in two or more diverse zones that result in one zone having a different perforation configuration, which may include varied depths, diameters, quantity, arrangement, spacing, etc., than another zone.

FIG. 2(c) illustrates that the multi-zone well 10 may also be re-perforated to further alter the perforation configuration in one or more of the zones. In FIG. 2(c), the re-perforation step changes the perforation configuration in high perm zone 12 to remove the choke that was applied by the perforation configuration of FIG. 2(b). While not required in all implementations of the present techniques, the re-perforation step may be accompanied by a re-treatment step to further change the properties of the formation.

FIG. 2(d) then illustrates the resultant production profile following the exemplary implementation of the present methods. Specifically, FIG. 2(d) illustrates that the high perm zone 12 and the low perm zone 14 are producing at the same rate (as represented by the flow arrows 16 having the same length). While a treatment operation to balance or equalize the production rates from two or more diverse zones may be the desired production profile following application of the present methods, other production profiles may be configured utilizing the present methods. For example, the high perm zone 12 can be left with a lower production rate than the low perm zone 14 (if desired) by leaving some of the choke effect in place or by configuring the treatment operations accordingly.

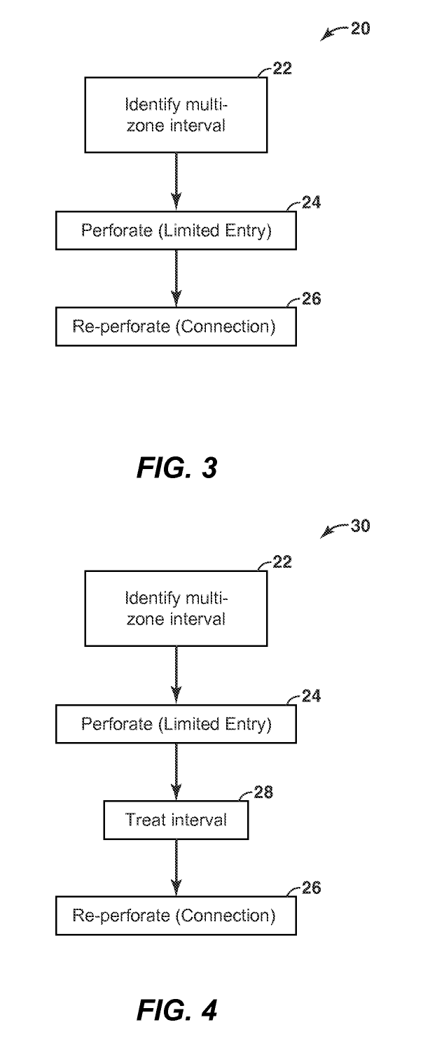

As suggested by the foregoing discussion, the present technologies provide methods for regulating or controlling flow in a well having at least two dissimilar zones. FIG. 3 provides a flow chart of one implementation 20 of methods according to the present disclosure. Specifically, FIG. 3 illustrates that some implementations begin by identifying a multi-zone interval at 22.

A multi-zone interval is any interval of the well that has two or more lengths that have different formation properties, which may include reservoir properties, near-well properties, skin properties, and/or underlying geologic properties. Common differences that may be present within an interval include different permeability, porosity, skin, lithology, reservoir pressure, stress state, and fluid saturation. Other properties or parameters of the well may vary along the length thereof.

An interval for the purposes of the present discussion is a length of well having no isolation elements placed therein to provide mechanical separation. Accordingly, a well may include multiple intervals defined by packers, plugs, or other isolation elements at one or more of the ends. Within each interval the production from the formation (or the fluid to be injected or applied to the formation) is commingled.

The methods 20 of FIG. 3 continue by perforating, at 24, and re-perforating, at 26. The perforating step 24 and the re-perforating step 26 are generally spaced by one or more operations in the well, such as applying a treatment, injection operations, or producing from the well. As suggested by FIG. 3, the perforating step 24 may apply a limited-entry perforation strategy while the re-perforating step 26 may apply a perforation connection strategy. As described above, the limited-entry perforation strategy may be configured to perforate the multi-zone interval in any manner suitable to obtain the desired choke effect (or flow control) in the respective zones of the interval. Accordingly, while FIG. 2 illustrated just two distinct zones, an actual well interval may have any number of zones having higher or lower permeabilities in any order or sequence. As such, the limited-entry perforating strategy may be customized for a particular interval. The perforation configuration for a particular zone will increase or decrease the frictional resistance to fluid flow into or out of the formation, thereby regulating the injectability and/or producibility of the zone.

Continuing with the exemplary methods of FIG. 3, the limited-entry perforating step 24 may be followed by producing from the interval. As the production continues from the various zones, one or more of the properties of the zone(s) will change as well. For example, the reservoir pressure may change to a greater or lesser degree for one zone than for another zone. Referring back to FIG. 2(a), for example, it is possible that the reservoir pressure in the high permeability zone 12 decreases at a faster rate than the reservoir pressure in the low permeability zone 14. In such an event, there may be a time during production when the choke applied by the limited-entry perforation is no longer desired, or at least not desired to the same degree as when applied. According to the present methods, the well, or a portion thereof, may then be re-perforated, at 26, according to a re-perforation strategy designed to have at least a portion of the re-perforations intersect with or connect with at least a portion of the original limited-entry perforations.

FIG. 4 schematically illustrates additional exemplary methods within the scope of the present disclosure, where similar steps or elements are referred to by the reference numbers of FIG. 3. FIG. 4 is similar to FIG. 3 but illustrates a treatment method 30 employing the current methods. Similar to FIG. 3, the treatment method 30 begins by identifying a multi-zone interval at 22. The multi-zone interval is then perforated according to a limited-entry perforation strategy, illustrated as step 24. As suggested by the schematic of FIG. 2, the limited-entry perforation strategy is adapted to limit or choke flow into some zones while encouraging flow into other zones. A treatment is then applied to the interval at step 28. Assuming the treatment being applied is a treatment designed to improve permeability of the interval, the limited-entry perforation strategy may be adapted to limit treatment fluid flow to zones that are known to have high permeability to allow a greater portion of the treatment fluid to contact the low permeability zones. FIG. 4 illustrates that the method further includes re-perforating following the treatment operation.

While the foregoing example of FIG. 4 and the schematic representations of FIG. 2 discuss permeability as a formation or interval property to be treated or considered when applying the present methods. Any other property may similarly be considered or treated. For example, the relative porosity of the zones in an interval may be considered in designing the limited-entry perforation strategy, the re-perforation strategy, and/or the treatments that may be applied. Additionally or alternatively, properties such as skin, lithology, reservoir pressure, stress state, and/or fluid saturation may be considered in developing the limited-entry perforation strategy, the re-perforation strategy, and/or the treatments that are applied in implementing the present methods.

One exemplary implementation of the present methods utilizes a limited-entry perforation strategy and a re-perforation strategy with an intervening carbonate matrix acidizing treatment to strategically treat a multi-zone well according to the different properties in the different zones. For example, a well having multiple zones of differing permeabilities, such as illustrated in FIG. 2, may be strategically treated according to the present techniques. Similarly, wells having multiple zones differing in any other property may be treated through application of the present techniques, though the treatment fluids or steps may be different than in the exemplary matrix acidizing.

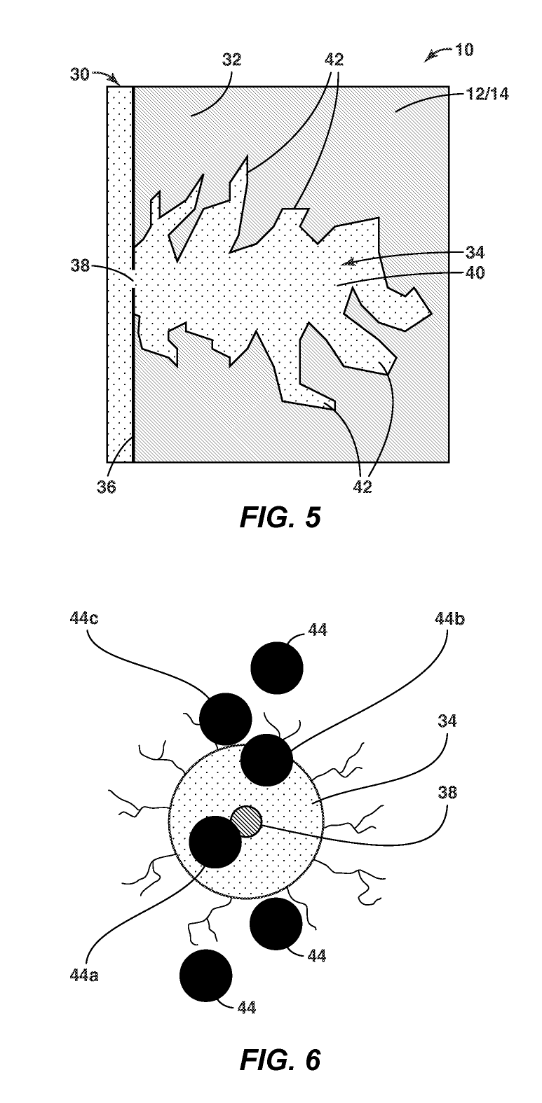

FIGS. 5 and 6 illustrate a schematic view of a portion of a well 10, including a well 30, a formation 32, and a wormhole 34 being formed by a matrix acidizing treatment. The representation of FIG. 5 is an illustrative characterization of a wormhole 34 being formed in the formation 32 by a matrix acidizing treatment, which wormhole could be formed in any zone in the well. FIG. 5 also illustrates a casing 36 separating the well 30 from the formation 32 and a perforation 38 through the casing providing fluid communication between the well and the formation. FIG. 6 illustrates a schematic view of the same wormhole 34 from the perspective of inside the well looking at the cased well wall.

In the illustration of FIG. 5, the perforation 38 is a limited-entry perforation through which the matrix acidizing treatment has been applied. As can be seen in FIG. 5 and as generally known, the wormhole 34 formed by the acid treatment extends into the formation away from the perforation. As seen in FIGS. 5 and 6, the wormhole, in addition to spreading away from the perforation into the formation, forms an open core 40 from which several arms or branches 42 extend. Depending on the properties of the formation 32 and the acid treatment being applied, the wormhole 34 will develop in different ways, such as long (in the radial direction away from well) and skinny (in the longitudinal direction of the well) or short and fat.

One difficulty in implementing the present methods is determining or designing the re-perforation strategy so that the re-perforations accomplish their desired impact. Specifically, it is desirable that the re-perforation step provide perforations that intersect with or connect with the initial limited-entry perforations and/or the wormhole 34 (or other formation features, such as fractures) created by the treatment operation or other well operation between the limited-entry perforations and the re-perforations. FIG. 6 illustrates an example of a re-perforation operation wherein the re-perforations 44 are close to the limited-entry perforation 38. However, from the schematic of FIG. 6 it can be seen that only one 44a of the re-perfs 44 managed to intersect the original limited-perforation while one other re-perf 44b intersects the wormhole core 40 and one other reperf 44c appears to overlap a branch 42. The remainder of the re-perforations may be successful conventional perforations, but they are not positioned to take advantage of the treatment operation or to otherwise coordinate with the limited-entry perforations 38. In some implementations, the treatment operations performed on the well following the limited-entry perforations may be specifically adapted to provide an enlarged target, such as the wormhole 34 formed by matrix acidizing, to facilitate aligning the re-perforations with the limited-entry perforations and/or the treated area behind the casing.

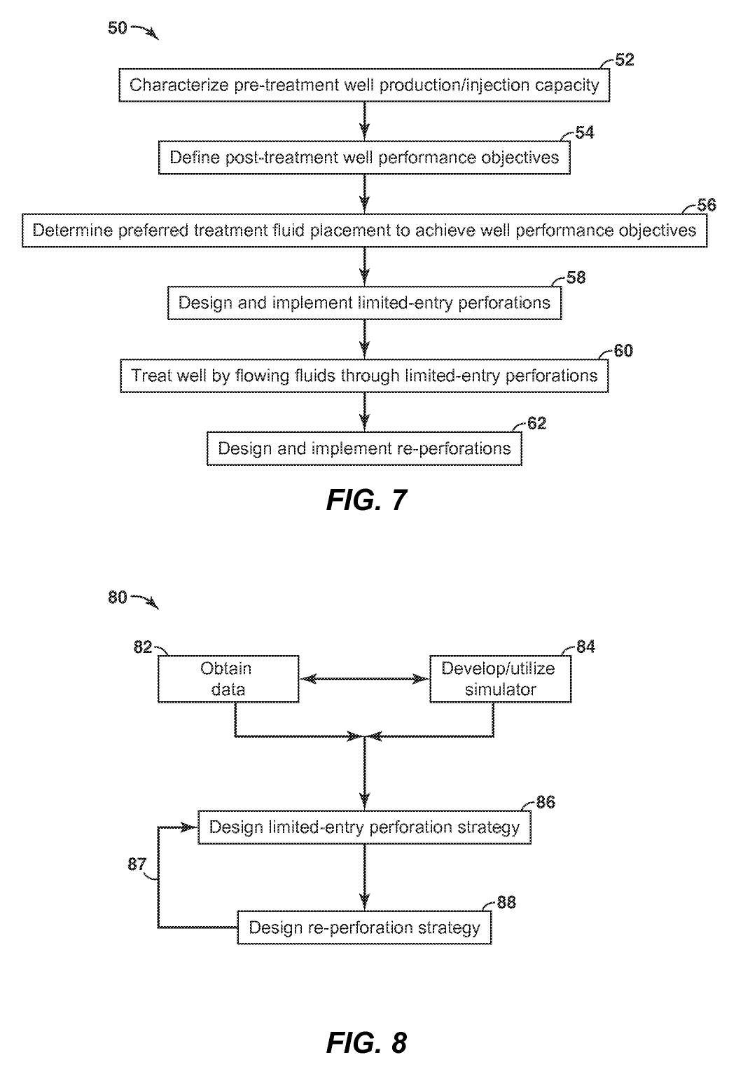

FIG. 7 provides another exemplary flow chart of methods within the scope of the present disclosure. FIG. 7 and the associated discussion relates to implementations including a treatment step between the limited-entry perforation step and the re-perforation step. Many of the principles discussed in connection with FIG. 7 can be applied to production and/or injection operations by extension and/or analogy. The treatment procedure 50 of FIG. 7 begins at 52 by characterizing the pre-treatment well production (or injection) capacity. A variety of conventional parameters or data may be used to characterize the well, including measured data and/or well performance models. The well production characterization may include factors or parameters such as permeability, skin, porosity, lithology, reservoir pressure, stress state, and fluid saturation. In some implementations, the well pre-treatment characterization may additionally or alternatively characterize the well simply by production/injection capacity, such as a volumetric rate. The step of characterizing the pre-treatment capacity will often reveal that a given well can be divided into multiple zones. Accordingly, the pre-treatment capacity characterization may characterize each of the zones distinctly.

At 54, the method 50 continues by defining post-treatment well performance objectives. These objectives may be developed in any manner including operator experience based on the pre-treatment characterization, modeling, and other available methods. For example, it may be determined that a particular well would be best served by producing at a given flow rate, which may be accomplished by producing one or more of the different zones at a different rate. The desired or target rate of production and/or injection may be influenced by any one or more of several conventional factors, such as maximizing the life of the well, maximizing the recovery from the well, maintaining or obtaining a desired hydraulic condition in the well or in the field, etc.

At 56, the treatment procedure 50 continues by determining the preferred treatment fluid placement to accomplish the objectives defined at step 54. The preferred treatment fluid placement may be determined with the assistance of modeling, experience-based input, or through other methods. Knowing the pre-treatment and post-treatment characteristics, including parameters such as permeability, porosity, etc., it is possible to determine the relative treatment levels and/or treatment methods appropriate for a particular zone. For example, it may be determined that some percentage of a stimulation treatment fluid should be delivered to one zone while a different percentage should be delivered to another zone. Similarly, it may be determined that a certain volume of treatment fluid should go to one zone while a different volume is required in another zone. The accomplishment of the post-treatment objectives may be dependent on creating the right conditions in the well in each of the multiple zones. For example, a particular zone may need to have its permeability increased while in another zone it may be preferred to mitigate flow impairment due to formation damage.

Conventionally, packers or other isolation devices would be used to deliver the proper amount of treatment fluid to the different zones. According to the present disclosure, however, the treatment fluid can be strategically delivered to the respective zones without such mechanical isolation equipment. At 58, the treatment procedure continues by designing and implementing a limited-entry perforation strategy. The limited-entry perforation strategy may be designed to provide different perforation configurations along the length of the well, such as a specific configuration for each zone in the interval. Additionally or alternatively, the design of the limited-entry perforation strategy may include providing two or more distinct zones with the same perforation configuration, such as when hydraulic forces compensate for differences in the formation properties between the two zones. Still additionally, some of the perforations designed and implemented as part of the limited-entry perforation strategy may be configured similar to conventional perforations. The perforations of the limited-entry perforation strategy are denominated limited-entry perforations' because they are strategically applied to the well to accomplish the selective treatments determined at step 56.

More specifically, the limited-entry perforations are designed and implemented to yield a pre-determined choke for regulating the distribution of treatment fluids to match the ideal or preferred distribution determined in step 56. Additionally, the limited-entry perforations are designed and implemented to create optimal conditions for subsequent removal of the choke. As discussed above, the choke of a limited-entry perforation may be desired at the time of implementation but subsequently become undesired, such as after a treatment operation. Accordingly, implementations of the present technology include designing the limited-entry perforations to facilitate the subsequent removal of the choke imposed by the limited-entry perforation as compared to flow through a conventional perforation.

With continuing reference to FIG. 7, the method 50 includes treating the well by flowing fluids through the limited-entry perforations, at 60. As indicated above, the flow of fluids through the limited-entry perforations may be choked according to the limited-entry perforation strategy. The treatment of the well may continue for a predetermined time. Additionally or alternatively, the treatment may be applied according to a treatment routine or method, such as flowing different fluids into the well during different periods of the treatment operation. The treatment operations may include any suitable conventional treatment operation, such as matrix acidizing, fracturing, etc. By analogy to production and/or injection operations, the treatment step 60 may constitute an operating step, such as producing or injecting, which may continue until the operating conditions fall outside of a desired operating range. For example, it may be observed that the production rate from the well falls below a threshold level suggesting that a previously applied choke may no longer be suitable or desired.

At step 62, the method 50 of FIG. 7 includes designing and implementing a re-perforation strategy. The re-perforation strategy is designed at least in part based on the limited-entry perforation strategy. Additionally or alternatively, the re-perforation strategy is based at least in part on the changes to the well and formation during the treatment step 60. For example, the re-perforation strategy is adapted to at least substantially align a portion of the re-perforations with a portion of the limited-entry perforations. In implementations including a treatment step, the re-perforation may be sufficiently aligned with the limited-entry perforation when the re-perforation connects with the treated formation behind the limited-entry perforation, such as the wormhole 34 illustrated in FIG. 5. In some implementations, substantially aligned may refer to sufficient alignment to fluidically connect the re-perforation with the limited-entry perforation. In other implementations, the well, the casing, and/or the formation may render tighter alignment preferable.

While a subsequent perforation step can have a high likelihood of having one or more perforations align with a prior perforation step (or otherwise come sufficiently close to the prior limited-entry perforation) by simply maximizing the number of perforations, such effective removal of the casing (by maximizing the perforation quantity and dimension in the subsequent perforation step) may not be desirable from a cost and/or completion integrity standpoint. Additionally or alternatively, when the re-perforation is applied following a treatment operation, the re-perforation is generally intended to perforate the casing in the treated area of the formation so as to benefit from the applied treatment. Accordingly, in order to maximize the probability that the re-perforations connect with the limited-entry perforations and/or the treated formation behind the limited-entry perforations, the re-perforations are applied according to a strategy, which may be based at least in part on the limited-entry perforation strategy and/or the formation properties.

Various aspects of the perforation steps, including the limited-entry perforations and the re-perforations, may be varied or controlled to enable the limited-entry perforations and the re-perforations to be aligned. As one example, the perforating guns may be provided with position orienting equipment to aid the operator in disposing the charges at the right depth within the well. Additionally or alternatively, the perforating guns may be configured to allow radial control over the firing direction of one or all of the charges. For example, the perforating gun may allow azimuthal orientation control by rotating the gun in its entirety or as distinct sections of the gun(s). This orientation control may be achieved through either active or passive means that may include eccentric weighting, swivels, rollers, or other components and other oriented perforating techniques that are well-known to the industry. Additionally or alternatively, the size or configuration of the charges may be varied to change the depth and/or configuration of each perforation. Other variations on the perforating gun equipment to enable control over the perforations may be suitable.

Additionally or alternatively, the methods of the present disclosure may include steps to inform the operator's/designer's development of the limited-entry perforation strategy and/or the re-perforation strategy. FIG. 8 presents a schematic flow chart of steps that may be implemented in cooperation with any of the methods discussed above, including the methods of FIGS. 3, 4, and 7. As discussed above with reference to FIG. 3, the basic steps of the present methods include identifying a multi-zone interval, perforating the interval according to a limited-entry strategy, and re-perforating the interval according to a connected perforation strategy. FIG. 8 illustrates schematically a design method 80 that may be used in designing the strategies that are implemented at the well site. The design method 80 begins at step 82 by obtaining data about the well, including information about one or more of the well, the reservoir, the formation, the near-well formation, the completion, etc. Additionally or alternatively, the design method 80 may begin at step 84 by developing and/or utilizing a simulator

As illustrated in FIG. 8, the data regarding the well (or about wells generally) may be utilized in developing the simulator at step 84. For example, a previously developed simulator may be modified or adapted to better simulate a given well or field. Additionally or alternatively, a simulator may be developed first such that the necessary data to be obtained is identified. The simulator developed and utilized at step 84 may incorporate one or more conventional models or simulations of various aspects of the well. Additionally, the simulator is adapted to consider the underlying physics that govern the operation of the well. For example, the physics of fluid-flow through limited-entry perforations affects the fluid behavior on the formation side of the casing. The fluid behavior on the formation side of the casing combined with the near-well formation and completion properties affects how a treatment fluid impacts the formation in the near-well formation.

While tables, correlations, and simplified equations have historically been used to represent these interactions for estimates of what might happen downhole, physics-based models can more accurately determine how a given combination of factors will affect a well over time. For example, simulators within the scope of the present disclosure may take as inputs a variety of parameters regarding the formation, the completion, the perforations, and the treatment to be applied, and may generate data showing the effect on the formation behind the casing of the treatment. Accordingly, with the use of such simulators, the dimensions of a wormhole may be modeled. Similarly, the simulator may be adapted to model the changes in the formation following a fracture treatment or after a period of production or injection operations. The specific equations, relationships, models, and other information that is incorporated into the simulators of the present discussion may vary depending on the field or well being considered.

Continuing with FIG. 8, the design method 80 continues by utilizing the simulator to design a limited-entry perforation strategy at step 86. For example, the simulator may take as inputs various parameters about the well and formation and the type of treatment to be applied. The simulator may also take as an input the desired well performance following the treatment. As a result, the simulator may produce data about the perforations to be applied to the various zones of an interval. In some implementations, the simulator may provide differing levels of specificity, leaving more or less designing for the operator/designer. For example, the simulator may produce data regarding effective permeabilities to be created in the various zones through the limited-entry perforations and leave the operator/designer to determine the specific limited-entry perforation strategy for the interval, including the perforation configuration for each of the zones. Alternatively, the simulator may provide the user with specifics about the limited-entry perforation configuration to be applied to each of the zones, such as the depth, size, spacing, etc. of the perforation strategy.

FIG. 8 further illustrates that the design method 80 includes designing a re-perforation strategy at step 88, which is linked to the design of the limited-entry perforation step 86. As suggested by the above discussion, the re-perforation strategy is designed based at least in part on the limited-entry perforation strategy. In some implementations of the simulator that produce robust and specific limited-entry perforation configurations, the re-perforation configuration strategy may similarly be produced by the simulator as a coupled solution to the problem of obtaining the desired post-treatment well performance. Alternatively, the simulator may be adapted to allow the operator/designer to vary one or more of the simulator outputs (in either the limited-entry strategy or the re-perforation strategy) and re-run the simulator to check the results following the proposed variation. For example, the design method 80 may allow an operator to utilize a simulator to design and/or assist in the design of a limited-entry perforation strategy. The final limited-entry perforation design may then be utilized by the simulator and/or a designer in designing and/or assisting in the design of the re-perforation strategy. In some implementations, the limited-entry perforation strategy may be reconsidered following the design of the re-perforation strategy to check the compatibility of the two designs, as indicated by the feedback loop 87 in FIG. 8. As previously indicated, implementations of the present systems and methods may utilize the simulators to a greater or lesser degree in the design of the perforation strategies. Some implementations may use the simulators merely to model the well and/or formation, leaving the perforation strategy design entirely to operators/designers. Other implementations, may utilize simulators with the ability to design perforation strategies and to incorporate the physics of the proposed perforations into the models/simulations.

While the inputs to and outputs from the simulator may vary depending on the intended sophistication of the simulator (i.e., how much of the design is desired to be left for the operator, required spatial and temporal resolution, inclusion/exclusion of certain physical effects), simulators of the present methods are able to consider the physics of the interactions between the formation and the treatments or operations performed on the formation by way of operations in the well. For example, the growth of a wormhole 34 (shown in FIG. 6) during a carbonate matrix acidizing treatment will be modeled by the simulator. Similarly, the producibility or injectability of a well zone following a treatment will be modeled by the simulator. The simulator will similarly be adapted to consider the impacts of a two-stage perforation treatment, including a limited-entry perforation step, followed by a well operation, and followed by a re-perforation step.

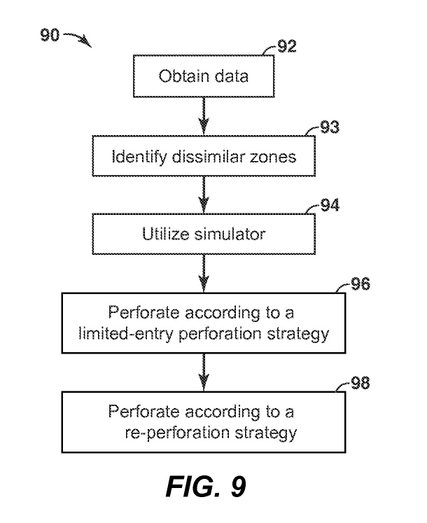

While some implementations of the present techniques are illustrated in the steps of the design method 80 of FIG. 8, FIG. 9 illustrates an extension of the design method 80 into an implementation method 90. The implementation method of FIG. 9 includes the steps of obtaining data 92 and utilizing a simulator 94 similar to the design method of FIG. 8. The simulator utilized in the implementation method 90 may be run on-site or off-site depending on the implementation of the simulator and the technical capabilities of the field operations. Additionally, the implementation method of FIG. 9 illustrates that the obtained data may enable an operator or designer to identify dissimilar zones in the well, such as at step 93. Additionally or alternatively, the simulator may be adapted to accept raw data about the well and formation and to identify the portions or segments of the well that are sufficiently similar to be grouped as distinct zones. In some implementations, the change in well characteristics may be gradual along the length thereof rendering the identification of distinct zones difficult. In such implementations, the simulator may be adapted to recommend depths or positions within the well that would be preferred zonal definitions for application of a particular perforation strategy and/or treatment operation.

FIG. 9 continues to illustrate that implementation methods 90 include the steps of perforating according to a limited-entry perforation strategy 96 and perforating according to a re-perforation strategy 98. As discussed above, the implementation method utilizes a simulator to develop limited-entry perforation strategies and re-perforation strategies. The development of the perforation strategies is based at least in part on the obtained data and may be done in the field or the data may be sent to a remote location for utilization of the simulator. The perforation steps, both limited-entry and re-perforation, may be accomplished using conventional perforation equipment. In some implementations, perforation equipment enabling control of the perforation location (along the well longitudinal dimension), penetration depth (into the formation), and/or azimuthal orientation may be preferred.

In some implementation methods 90, additional data may be collected (not shown) following the limited-perforation step 96. The additional data may be information regarding the limited-entry perforations to confirm the effectiveness and accuracy of the operator's perforation step. In some implementations, this post-limited-entry perforation data may be input into the simulator to confirm the previously generated re-perforation strategy. Additionally or alternatively, the re-perforation strategy may not even be considered or designed until data regarding the effectiveness and/or accuracy of the limited-entry perforation is obtained. Similarly, in implementations including a treatment step, such as illustrated in FIG. 7, additional data may be obtained following the treatment step 60 to enable the re-perforation strategy to be updated and/or designed in accordance with conditions existing after the treatment operation. For example, the initial re-perforation strategy may be designed prior to the limited-entry perforation step. Due to the number of variables and uncontrolled factors in well operation, the limited-entry perforation step and/or the treatment step may not proceed exactly as predicted by the simulator. A more effective re-perforation strategy may be developed through utilization of the simulator with the additional data provided following one or more of the limited-entry perforation step and the treatment step.

The simulator developed and/or utilized in the methods of FIGS. 8 and 9 enables the re-perforation strategy to be designed based on accurate simulations of conditions in the formation behind the casing. For example, the open core 40 (see FIG. 6) of the wormhole will be revealed including its dimensions. Such information helps to answer the question of how close is close enough to connect the re-perforations with the limited-entry perforations. With the physics-based representations of the perforation and treatment behavior deep within the well, the operators are able to configure the perforating guns and equipment to at least substantially align at least a portion of the re-perforations with at least a portion of the limited-entry perforations and/or the openings formed during treatment operations. The degree of alignment or the relative portions of the perforations that are aligned may vary depending on the well. In some implementations, the simulator may determine the degree of alignment required to obtain the desired post-treatment well performance.

While the present techniques of the invention may be susceptible to various modifications and alternative forms, the exemplary embodiments discussed above have been shown by way of example. However, it should again be understood that the invention is not intended to be limited to the particular embodiments disclosed herein. Indeed, the present techniques of the invention are to cover all modifications, equivalents, and alternatives falling within the spirit and scope of the invention as defined by the following appended claims.

1. A method of regulating flow in a hydrocarbon well, the method comprising:
identifying in an interval of a well at least two dissimilar zones;
perforating a well completion in the interval according to a limited-entry perforation strategy to produce a plurality of limited-entry perforations, wherein the limited-entry perforation strategy varies within the interval based at least in part on dissimilarities between the at least two dissimilar zones; and
re-perforating the well completion in the interval according to a re-perforation strategy to produce a plurality of re-perforations, wherein the re-perforation strategy is based at least in part on the limited-entry perforation strategy and is adapted to at least substantially align a portion of the re-perforations with a portion of the limited-entry perforations.

2. The method of claim 1 wherein the at least two zones are dissimilar in at least one formation property.

3. The method of claim 2 wherein the at least two zones are dissimilar in at least one formation property selected from permeability, porosity, skin, lithology, reservoir pressure, stress state, and fluid saturation.

4. The method of claim 1 wherein the at least two dissimilar zones are within a single isolation interval.

5. The method of claim 1 further comprising designing the limited-entry perforation strategy based at least in part on dissimilarities between the at least two dissimilar zones.

6. The method of claim 5 further comprising obtaining formation property data related to the interval, and wherein designing the limited-entry perforation strategy utilizes formation property data to adapt the limited-entry perforation strategy to regulate flow into or out of the dissimilar zones.

7. The method of claim 5 further comprising utilizing one or more models of the interval to simulate effects of various limited-entry perforation strategies, wherein designing the limited-entry perforation strategy is based at least in part on the one or more models of post-limited-entry perforation performance.

8. The method of claim 5 wherein the plurality of limited-entry perforations apply a choke on fluid flow into or out of each of the zones, and wherein designing the limited-entry perforation strategy comprises selecting perforation properties for each zone to prepare each zone for re-perforating to remove the choke.

9. The method of claim 5 further comprising designing the re-perforation strategy, wherein at least a portion of the re-perforation strategy is designed concurrently with designing the limited-entry perforation strategy, and wherein the re-perforation strategy and the limited-entry perforation strategy are designed to cooperate to regulate flow within the interval.

10. The method of claim 1 wherein the interval includes at least one high permeability zone and at least one low permeability zone, and wherein the limited-entry perforation strategy is adapted to selectively perforate the dissimilar zones to have a greater impact on the at least one low permeability zone than on the at least one high permeability zone.

11. The method of claim 1 wherein for each of the dissimilar zones the limited-entry perforation strategy varies one or more perforation property selected from number of perforations, perforation diameter, perforation density, perforation depth, perforation phasing, perforation sequencing, preferred perforation distribution, preferred perforation gun disposition, and preferred perforation gun orientation.

12. The method of claim 1 further comprising pumping a treatment fluid into the interval following the limited-entry perforating and before the re-perforating.

13. The method of claim 12 wherein the limited-entry perforating strategy is adapted to regulate flow of the treatment fluid into one or more of the dissimilar zones.

14. The method of claim 13 wherein the dissimilar zones include at least one higher permeability zone and at least one lower permeability zone; wherein the treating fluid is selected to increase permeability; and wherein the limited-entry perforating strategy is adapted to preferentially allow treatment fluid to enter one or more lower permeability zones.

15. The method of claim 12 wherein the treatment fluid is selected to form wormholes in the zones behind the limited-entry perforations; and wherein at least a portion of the re-perforations are at least substantially aligned with at least a portion of the wormholes.

16. The method of claim 12 wherein the treatment fluid is selected from carbonate matrix acidizing fluids and fracture fluids.

17. The method of claim 12 wherein the treatment fluid is selected to change a formation within each of the zones, further comprising obtaining data regarding one or more formation property for each of the zones following the pumping of the treatment fluid, and further comprising designing the re-perforation design strategy based at least in part on information regarding the formation properties in each zone following the pumping of the treatment fluid.

18. The method of claim 1 further comprising utilizing the well for production or injection operations.

19. The method of claim 1 further comprising utilizing a simulator of the interval based at least in part on the obtained data and one or more physics-based rules to simulate effects of various limited-entry perforation strategies, wherein designing the limited-entry perforation strategy is based at least in part on the simulated post-limited-entry perforation performance.

20. The method of claim 19 wherein the at least two zones are dissimilar in at least one formation property.

21. The method of claim 20 wherein the at least two zones are dissimilar in at least one formation property selected from permeability, porosity, skin, lithology, reservoir pressure, stress state, and fluid saturation.

22. The method of claim 19 wherein for each of the dissimilar zones the limited-entry perforation strategy varies one or more perforation property selected from number of perforations, perforation diameter, perforation density, perforation depth, perforation phasing, perforation sequencing, preferred perforation distribution, preferred perforation gun disposition, and preferred perforation gun orientation.

23. The method of claim 19 wherein for each of the dissimilar zones the re-entry perforation strategy varies one or more perforation property selected from number of perforations, perforation diameter, perforation density, perforation depth, perforation phasing, perforation sequencing, preferred perforation distribution, preferred perforation gun disposition, and preferred perforation gun orientation.

24. The method of claim 19 further comprising utilizing the well for production or injection operations.

25. A method for designing treatments for a hydrocarbon well to regulate flow within the well, the method comprising:
obtaining data regarding one or more formation properties of a well having at least two dissimilar zones within a single interval;
developing a simulator of the interval based at least in part on the obtained data and one or more physics-based rules;
designing a limited-entry perforating strategy based at least in part on the obtained data and utilizing the simulator to model the interval; and
designing a re-perforating strategy based at least in part on the limited-entry perforating strategy and adapted to fluidly connect a plurality of re-perforations with a plurality of limited-entry perforations.

26. The method of claim 25 wherein the at least two zones are dissimilar in at least one formation property selected from permeability, porosity, skin, lithology, reservoir pressure, stress state, and fluid saturation.

27. The method of claim 25 wherein the simulator is adapted to simulate completion and near-well physics.

28. The method of claim 25 wherein designing the limited-entry perforating strategy comprises determining desired stimulation levels for each of the zones based at least in part on the utilization of the simulator.

29. The method of claim 25 wherein designing the limited-entry perforating strategy comprises determining preferred treatment fluid distributions to the at least two zones based at least in part on the utilization of the simulator.

30. The method of claim 25 wherein designing the limited-entry perforating strategy comprises determining at least one of preferred perforation diameter, preferred perforation density, preferred total perforations, preferred perforation depth, preferred perforation phasing, preferred perforation sequencing, preferred perforation distribution, preferred perforation gun disposition, and preferred perforation gun orientation to regulate flow within the interval.

31. The method of claim 25 further comprising obtaining updated data regarding the interval following application of the limited-entry perforation strategy and a treatment routine, and updating the simulator based at least in part on the updated data.

32. The method of claim 31 wherein designing a re-perforating strategy is based at least in part on the updated simulator.

33. The method of claim 31 wherein the treatment routine comprises pumping an acid into the well forming wormholes associated with limited-entry perforations created by the application of the limited-entry perforation strategy, and wherein designing the re-perforating strategy is adapted to fluidly connect a plurality of re-perforations with a plurality of the wormholes associated with limited-entry perforations.

34. The method of claim 25 wherein designing the re-perforating strategy comprises determining at least one of preferred perforation diameter, preferred perforation density, preferred total perforations, preferred perforation depth, preferred perforation phasing, preferred perforation sequencing, preferred perforation distribution, preferred perforation gun disposition, and preferred perforation gun orientation to fluidly connect a plurality of re-perforations with a plurality of limited-entry perforations.
